(19) United States
(12) Patent Application Publication
(10) Pub. No.: US 2004/0033049 A1
(43) Pub. Date: Feb. 19, 2004

(54) Compact platform for manufacturing coarse wavelength division multiplexing optical components

(75) Inventor: Zhouzheng Shi, Union City, CA (US)

Correspondence Address: Bo-In Lin, 13445 Mandoli Drive, Los Altos Hills, CA, 94022, US

(73) Assignee: PACTONIX, Inc.

(21) Appl. No.: 10/219,909

(22) Filed: Aug. 14, 2002

(51) Int. Cl. G02B 6/00

(52) U.S. Cl. 385/147

(57) ABSTRACT

A new low-cost, highly reliable and compact optical module is designed and manufactured with simplified structure and improved configurations by assembling multiple optical components onto a preformed platform. The platform includes a plurality of placement hollow-opening for placing and supporting the optical components on the platform at substantially predefined fixed position and orientation.

### FIELD OF THE INVENTION

This invention relates generally to a device configuration and method for making optical components. More particularly, this invention relates to a platform for manufacturing optical modules more economically that is suitable for metropolitan optical signal communication systems applying coarse wavelength division multiplexing (CWDM) technology that requires higher degrees of compactness and optical isolations with good thermal performance.

### BACKGROUND OF THE INVENTION

Even with rapid technical advances made in design, manufacture and cost-down improvements made in optical component for long-haul optical fiber communication systems, several technical challenges are still faced by those of ordinary skill in the art of designing and manufacturing optical devices more suitable for metro optical signal communication systems applying coarse wavelength division multiplexing (CWDM) technology. The technical challenges arise from the facts that technologies of even lower production-costs are required for the metro optical fiber components and that the metro optical components applying a CWDM technology often require a different set of performance requirements imposed by different operational environments and system configurations that are unique to the metro optical signal communication systems.

The metro optical communication network is an essential link to the end users for the purpose of bridging the gaps between current long haul optical networks and the “last mile” link to homes to expand the broadband telecommunication and multimedia transmissions employing the broadband networks taking advantage of the advancements made in the optical fiber technologies. As early as 1980s, a cost effective coarse wavelength divisional multiplexing (CWDM) system operated in the window of 800 nm with four channels, was deployed for digital video signal transmission over multimode optical fibers. Since then, multi-channel transmitter and receiver were also widely employed for transmissions throughout other wavelength ranges. However, all these cost effective systems were limited to networks linked by multimode optical fibers. The data transmission distance without relay was limited to no more than ten kilometers. On the other hand, the practical metro access network typical requires twenty to fifty kilometers of signal transmissions with combined data transmission rate of at least ten gigabits per second, i.e., 10 Gbits/sec, without signal amplification. In order to satisfy these requirements, single mode CWDM system was derived from the dense wavelength division multiplexing (DWDM) technologies employed for long haul optical networks.

However, unlike the DWDM technologies, the signals of a single mode CWDM are generated from an un-cooled distributed-feedback laser and are transmitted through broadband optical gates. The use of the un-cooled laser source significantly simplifies the light source and reduces the cost of optical signal generator. In the meantime, low power dissipation and high channel isolation signal transmissions are required in a metro optical system since the signals are unlikely being amplified during the transmission.

Considering some of the essential requirements for a metro optical network system such as low power dissipation, small size and low cost, the thin film technology would still be suitable for providing optical components of wavelength mixing and separation. However, a cascade configuration of the conventional optical modules applying the thin-film technology including those used for multiplexing/de-multiplexing modules has several drawbacks. The cascaded configuration is relative bulky in size and has a high production cost due to the necessity of fiber management and the complexity in device manufacturing processes. Additionally, since the cascaded configuration is derived from the long haul DWDM techniques for making optical components suitable for long haul applications, such configuration generally is not an optimal when implemented in a metro networks that require a high channel isolation while relaxing the thermal stability and central wavelength tolerances. Direct application of the conventional DWDM cascaded configurations to a system that requires only CWDM adds unnecessary complexities for performance requirements that are no longer required for metro systems but unduly increases the volume of the components and production costs.

For these reasons, there is still a need in the art of design and manufacture of CWDM optical components particular suitable for metro network applications to provide new and improved component platforms for module assembly to resolve the above technical difficulties limitations.

### SUMMARY OF THE PRESENT INVENTION

It is therefore an object of the present invention to provide a new platform to simplify the manufacturing processes of optical modules with reduced cost while provides reliable performance more suitable for CWDM applications such that the above mentioned difficulties and limitations may be overcome.

Specifically, it is an object of the present invention to provide a simple and reliable module configuration supported on a preformed platform ready for accommodating and placement of optical components at substantially predefined fixed positions and orientations to allow for simultaneous parallel manufacturing processes thus simplifying the assembling processes and lowering the production cost while increasing the module stability and performance reliability. By constructing and supporting the module on a preformed base significantly reduces the efforts of fiber routing management and reduces the size of the module. Thermal stability is improved by making use of low thermal expansion base. Adopting a quasi-parallel structure instead of the conventional cascaded configurations increases channel uniformity. A single platform may be formed for accommodating different kinds of modules thus further reduces the production costs and simplifies the design processes when the basic module configuration are defined with placement and orientation of optical components optimized according to a total module performance.

Briefly, in a preferred embodiment, the present invention discloses a new module configuration for assembling a plurality of optical components into an optical module. The optical module includes a preformed platform having a plurality of placement hallow-openings on the platform for placing and supporting the optical components at substantially predefined fixed positions and orientation. In a preferred embodiment, the hallow openings are formed on the preformed platform for placing and supporting a plurality of optical transmitting means substantially having a fishbone-shaped configuration. In a preferred embodiment, the hallow openings are formed on the preformed platform for placing and supporting a plurality of optical transmitting means substantially having a comb-shaped configuration.

These and other objects and advantages of the present invention will no doubt become obvious to those of ordinary skill in the art after having read the following detailed description of the preferred embodiment, which is illustrated in the various drawing figures.

### BRIEF DESCRIPTION OF THE DRAWINGS

FIG. 1 is a functional diagram of a fishbone shaped MUX/DEMUX module of this invention;

FIG. 2 shows a perspective view of a four-channel module of FIG. 1 supported on a platform of this invention;

FIG. 3 is perspective view showing the bonding of optical components to a groove drilled on the platform for accommodating and supporting the optical components at predefined fixed position and orientation;

FIG. 4 is perspective view showing a V-shaped groove drilled on the platform for accommodating and supporting cylindrical shaped optical components at predefined fixed position and orientation; and

FIG. 5 is perspective view a four-channel module formed as a comb-shaped module supported on a preformed platform of this invention.

### DETAILED DESCRIPTION OF THE PREFERRED EMBODIMENT

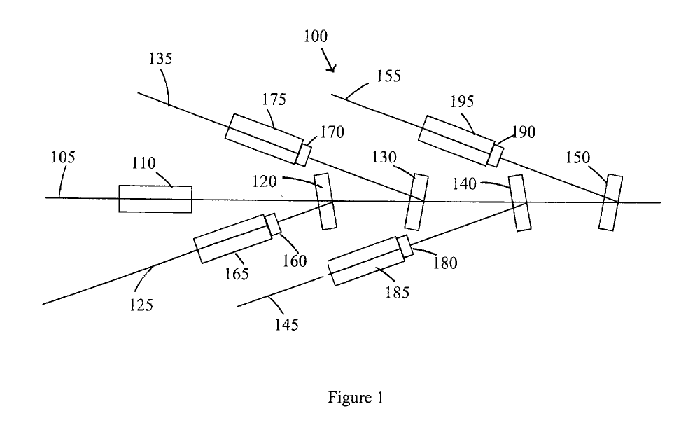

Referring to FIG. 1 for a preferred embodiment of a platform of this invention for configuring a four-channel CWDM multiplexing-and-demultiplexing module, i.e., a mux/demux module 100. For the module 100 to operate as a demultiplexing (DEMUX) module, a multiplexed optical signal comprising signals transmitted over four wavelengths λ1, λ2, λ3, and λ4 are introduced into the module through an input collimator 110. The multiplexed optical signal is sequentially separated by a group of edge filters 120, 130, 140 and 150 wherein each of the edges filters functions as an wavelength divider by reflecting the optical signal shorter than an edge wavelength, e.g., λ(120), while the remainder of the optical signals is passed through for projecting to a next edge filer having a longer edge wavelength λ(130) where λ(150)>λ(140)>λ(130)>λ(120). After reflecting by the edge filters 120, 130, 140, and 150, the reflected optical signal then passes through a band pass filter 160, 170, 180 and 190 respectively where each of the band pass filter is correlated to the bandwidth of the first, second, third, and fourth channels. After these reflected signal passes through the band pass filters 160, 170, 180, and 190, the optical signal is projected to an output waveguide or optical fiber 125, 135, 145, and 155 through an output collimator 165, 175, 185 and 195 respectively. In this embodiment, the edge wavelength of the edge filter sequentially increased, while in a different embodiment, the edge wavelengths of the edge filters can be provide to sequentially decrease as well.

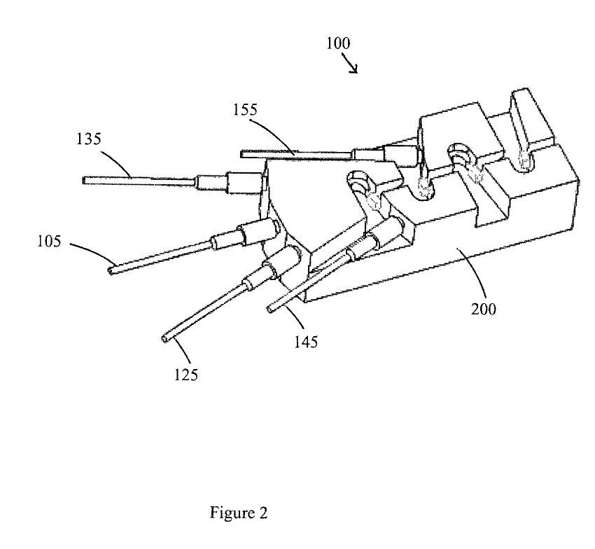

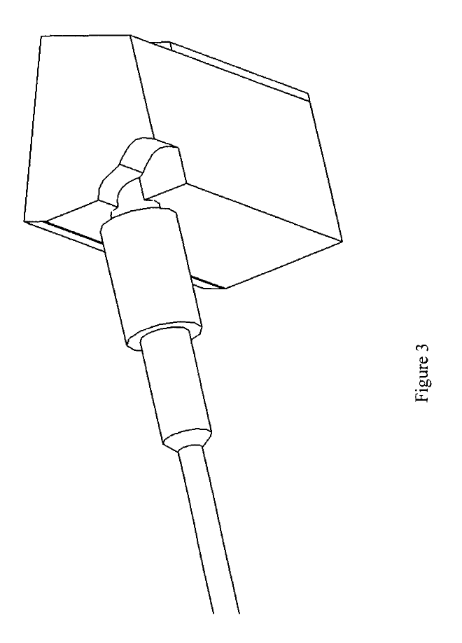

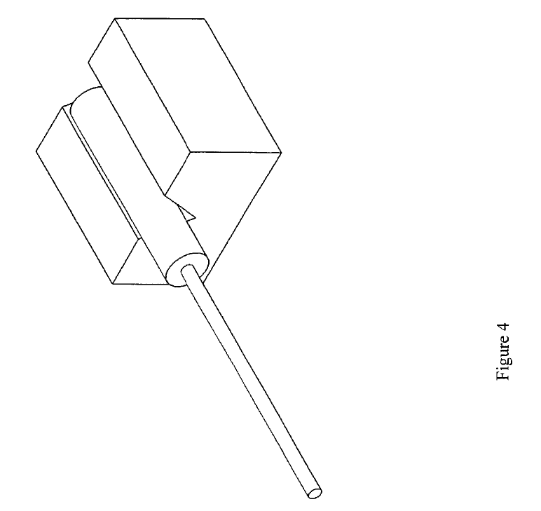

Referring to FIG. 2 for a perspective view of the DEMUX/MUX module 100 supported on a base frame serves the function as a platform 200. The platform 200 is preformed to have fixed shape and size according to a predefined configuration for fixed-position placement of the optical components and with preformed grooves for fixing the position of the optical fibers or waveguides for inputting or outputting optical signals of different wavelengths. The four-channel MUX/DEMUX module is configured as a “fishbone” shaped module. For the purpose of achieving maximum thermal stability, the module is formed as a up-level structure by applying an optical mounting technique where the grooves are carved out on the body of the base while the portion of the lower body is kept as a thick base to minimize thermal variations influence to the optical components mounted on the upper level structure under different operation temperatures. The material of the platform 200 is preferably selected from the metal alloys and special glasses with ultra-low thermal expansion coefficient. The collimators are mounted into the precisely drilled guide holes. The positions of the collimators are fine-tuned for optimization. Adhesive or metal bonding materials are then applied as that shown in FIG. 3 to maintain the optical components including the collimator placed into the drilled holes at fixed position. The cylindrical symmetry of the collimator mount as shown in FIG. 2 enhances the uniformity of the bonding strength. Meanwhile, the thermal stability of the entire system is improved. An alternative way of mounting the collimators is to utilize precision V-grooves as that shown in FIG. 4, which provides simple low cost solution when a more relaxed thermal stability is required.

Since the whole module is constructed on a base frame rather than by aligning a group of individual optical devices linked by optical fibers as that often implemented in a conventional optical module, the manufacturing processes are greatly simplified because there is not need to manage the fiber routing and excessive alignment. With the holes and grooves predefined on the platform 200, assembling the collimator in situ now provides more adjustment freedoms as the basic orientation and position are predefined and only fine-tuning adjustments are necessary. In situ adjustment at module level further provides the advantages that more performance parameters can be simultaneously monitored and adjusted to achieve higher total system performance when these adjustments can be simultaneously performed. Also the module size is significantly reduced. The relative positions between different optical channels are now arranged as quasi parallel instead of cascaded where the channels are arranged in serial sequence. Compared to the cascaded arrangement, the channel uniformity is improved, and meanwhile, the risk of system catastrophe is reduced with a quasi-parallel configuration as disclosed in this invention.

Since multiple channel orientations are predefined on the platform by precisely drilled holes and grooves, more simplified processes of module manufacture can be performed in parallel to reduced the time and costs of module assembly. Unlike the cascaded configuration employed in the conventional manufacturing methods, instead of serial alignment, multiple channel alignments can be performed simultaneously. The platform as that shown in FIG. 2 can be implemented for four channel MUX/DEMUX modules. Other functional modules could be configured based on this optical platform. With properly designed dual fiber collimators, a dual-function module can be configured on a single platform serving as a module base. When equipped with appropriate optical signal source, an integrated version of four-channel transmitter module can be formed on the platform base as well. By reciprocally replacing the laser sources with signal detectors, a four-channel receiver with built-in demultiplexing function can be conveniently configured. This platform can therefore be flexibly expanded to accommodate different kinds of optical modules or adopting more optical channels.

For metropolitan network applications, most of the optical transmissions are carried out without amplification and the network operation requires frequently add and drop of optical signals. For those reasons, higher channel isolation in the range of 50 dB to 55 dB is necessary. In order to achieve high channel isolation, double filter technique is commonly applied in the three-port device based systems and that causes the cost of implementation to increase and also degrade the system optical performances when extra filtering of the optical signals is added. The MUX/DEMUX module as showed in FIGS. 1 and 2 uses a combination of edge filter and band pass filter for channel separation. As the reflection side of the edge filter normally carries up to −18 dB signal from unwanted channels, a band pass filter in front of exit collimator with a channel isolation better than 35 dB can combine with the edge filter to achieve a an channel isolation of 50 dB to 55 dB. Although the total number of filters remains the same, a lower filtering performance requirement is now needed for a module configuration by combining an edge filter with a band pass filter. Using a configuration shown in FIGS. 1 and 2 thus provides the additional advantage of cost savings.

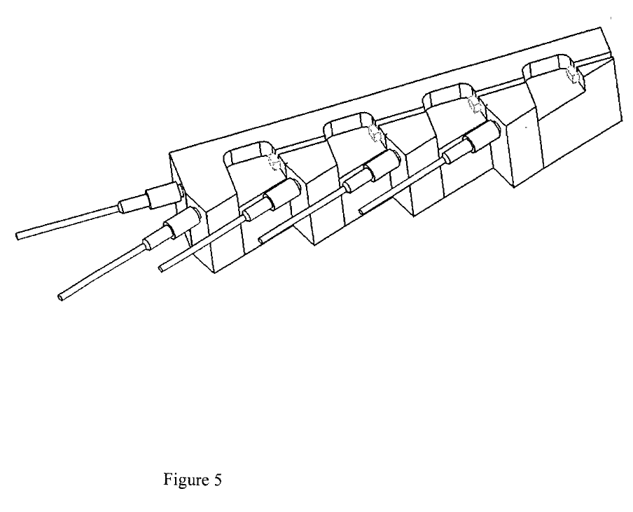

Referring to FIG. 5 for another four-channel CWDM MUX/DEMUX module assembly with “comb structure”. Compared with the “fishbone” configuration of FIG. 1, his structure reduces the width while increases the total length of the module. For the comb structure, the distance between the edge filters determines the total length of the module and normally the distance between the edge filters is limited by the incident angle, the size of the edge filters and the size of the collimators. A large incident angle is preferred for size reduction. However, polarization dependent insertion loss will increase significantly with the increase of the incident angle. Therefore, the incident angle is maintained at a compromised range between eight to ten degrees. For a fishbone configuration, the overall size of the module is practically determined by the size of the edge filters and its mounting while the size of the collimator is a major factor in determining the module size of a comb configuration. Generally, the fishbone structure is approximately thirty percent smaller than the comb structure. For this reason, the fishbone structure is preferred for metro applications. Further size reduction can be achieved by arranging the exit ports in three-dimensional space around the principle optical axis to form an umbrella structure. More channel can be accommodated when the three dimensional space is utilized.

According to FIGS. 1 to 5 and above descriptions, this invention discloses an optical module having a plurality of optical components. The optical module further includes a platform having a plurality of placement hallow-openings opened on the platform for placing and supporting the optical components at substantially predefined fixed positions and orientation. In a preferred embodiment, the hallow openings are opened on the platform for placing and supporting a plurality of optical transmitting means substantially having a fishbone-shaped configuration. In another preferred embodiment, the hallow openings are opened on the platform for placing and supporting a plurality of optical transmitting means substantially having a comb-shaped configuration. In another preferred embodiment, at least one of the hallow openings is an opened groove for placing a optical fiber therein. In another preferred embodiment, the optical components placed in the hollow openings are further securely fixed and bonding to the platform with an adhesive material. In another preferred embodiment, the platform composed of material of thermal expansion coefficient smaller than one micro-meter/° C. (μm/m° C.). In another preferred embodiment, the optical module is a multiplexing/demultiplexing (MUX/DEMU) module comprising an input transmitting means placed in an elongated hollow opening extended over the platform for inputting a multiplexed signal. And, a plurality of edge filters disposed along the input transmitting means and a corresponding demultiplexed signal transmitting means connected to each of the edge filter wherein each of the edge filter sequentially reflecting a demultiplexed signal to the corresponding demultiplexing transmitting means for carrying out a multiplexing-and-demultiplexing function. In another preferred embodiment the corresponding demultiplexed signal transmitting means are disposed on both sides of the input transmitting means and are aligned substantially in parallel thus constituting a fishbone shaped MUX/DEMUX module. In another preferred embodiment, the corresponding demultiplexed signal transmitting means are disposed on one side of the input transmitting means and are aligned substantially in parallel thus constituting a comb shaped MUX/DEMUX module. In another preferred embodiment, each of the demultiplexed signal transmitting means further comprising a band-pass filter for increasing a channel isolation for the MUX/DEMUX module and the bandpass filter is connected to a collimator.

This invention further discloses an optical module platform. The platform includes a plurality of placement hallow-openings opened on the platform for placing and supporting a plurality of optical components at substantially predefined fixed positions and orientation. In a preferred embodiment, the hallow openings are opened on the platform for placing and supporting a plurality of optical transmitting means substantially having a fishbone-shaped configuration. In another preferred embodiment, the hallow openings are opened on the platform for placing and supporting a plurality of optical transmitting means substantially having a comb-shaped configuration. In another preferred embodiment, the platform composed of material of thermal expansion coefficient smaller than one micro-meter/° C. (μm/m° C.).

The platform for supporting and precise placement of module components as show in FIGS. 2 to 5 can be implemented for manufacturing other functional modules. By replacing all single fiber input and output collimators with dual input/output collimators, a dual MUX and DEMUX module can be built on a single platform and can be employed as a combined MUX and DEMUX module. The fiber separation of two fibers inside the collimator for single channel should be set to match the separation for a multiple-channel collimator based on the relative position of these collimators as defined by the following functional relationship:

Di=fifD/(LiS−Lif−Sf−Sfi+ffi)

Where Di is the distance between fibers in dual fiber collimator, fi is the focus length for i-th channel; D and f are the distance between the fibers and the focus length for the input collimator respective, S is the parameter which controls the work distance for the input collimator and Li is the distance between the input collimator and the i-th exit port. For the purpose of obtaining a best coupling effect, Di and fi are individually adjusted according to each specifically distance Li between the input collimator and the i-th exit port.

The platform may be used to support a multi-channel transmitter module by replacing all single channel collimator with collimated laser source. A four-channel transmitter with a MUX module can be built on the platform as shown in FIG. 2. Operating at corresponding wavelength, each laser source can be modulated separately. A compact multi-channel transmitter with high signal coupling efficiency can be conveniently assembles with a platform as disclosed in this invention according to various preferred embodiments a shown in above examples. Similar structure can be converted to a multi-channel receiver. Signal detectors are placed at four exit ports with simple light-focusing optical element placed in front of the signal detectors. Optical signals are converted into electrical signals right after the signals are de-multiplexed. Thus, lower signal loss can be achieved and longer data transmission without amplification is feasible when the optical energy transmission is handled and managed more efficiently with improved optical module supported on a platform of this invention.

This invention further discloses a method for configuring an optical module. The method includes a step of supporting a plurality of optical components on a platform by opening a plurality of placement hallow-openings on the platform for placing and supporting the optical components at substantially predefined fixed positions and orientation. In a preferred embodiment, the step of opening the hallow openings on the platform is a step of opening the hollow-openings for placing and supporting a plurality of optical transmitting means substantially having a fishbone-shaped configuration. In another preferred embodiment, the step of opening the hallow openings on the platform is a step of opening the hollow-openings for placing and supporting a plurality of optical transmitting means substantially having a having a comb-shaped configuration. In another preferred embodiment, the step of opening the hallow openings on the platform is a step of opening at least one of the hollow-openings as an open groove for placing and supporting a fiber optical therein. In another preferred embodiment, the method further includes a step of securely bonding and fixing the optical components placed in the hollow-openings to the platform with an adhesive material. In another preferred embodiment, the method further includes a step of forming the platform with a material having a thermal expansion coefficient smaller than one micro-meter/° C. (μm/m° C.).

In essence, this invention discloses a method for forming an optical module. The method includes a step of opening a plurality of placement hallow-openings on the platform at substantially predefined fixed positions and orientation provided for placing and supporting a plurality of optical components therein.

Although the present invention has been described in terms of the presently preferred embodiment, it is to be understood that such disclosure is not to be interpreted as limiting. Various alternations and modifications will no doubt become apparent to those skilled in the art after reading the above disclosure. Accordingly, it is intended that the appended claims be interpreted as covering all alternations and modifications as fall within the true spirit and scope of the invention.

I claim:

1. An optical module having a plurality of optical components further comprising:
a platform having a plurality of placement hallow-openings opened on said platform for placing and supporting said optical components at substantially predefined fixed positions and orientation.

2. The optical module of claim 1 wherein:
said hallow openings are opened on said platform for placing and supporting a plurality of optical transmitting means substantially having a fishbone-shaped configuration.

3. The optical module of claim 1 wherein:
said hallow openings are opened on said platform for placing and supporting a plurality of optical transmitting means substantially having a comb-shaped configuration.

4. The optical module of claim 1 wherein:
at least one of said hallow openings is an opened groove for placing a optical fiber therein.

5. The optical module of claim 1 wherein:
said optical components placed in said hollow openings are further securely fixed and bonding to said platform with an adhesive material.

6. The optical module of claim 1 wherein:
said platform composed of material of thermal expansion coefficient smaller than one micro-meter/° C. (μm/m° C.).

7. The optical module of claim 1 wherein:
said optical module is a multiplexing/demultiplexing (MUX/DEMU) module comprising an input transmitting means placed in an elongated hollow opening extended over said platform for inputting a multiplexed signal; and
a plurality of edge filters disposed along said input transmitting means and a corresponding demultiplexed signal transmitting means connected to each of said edge filter wherein each of said edge filter sequentially reflecting a demultiplexed signal to said corresponding demultiplexing transmitting means for carrying out a multiplexing-and-demultiplexing function.

8. The optical module of claim 7 wherein:
said corresponding demultiplexed signal transmitting means are disposed on both sides of said input transmitting means and are aligned substantially in parallel thus constituting a fishbone shaped MUX/DEMUX module.

9. The optical module of claim 7 wherein:
said corresponding demultiplexed signal transmitting means are disposed on one side of said input transmitting means and are aligned substantially in parallel thus constituting a comb shaped MUX/DEMUX module.

10. The optical module of claim 7 wherein:
each of said demultiplexed signal transmitting means further comprising a band-pass filter for increasing a channel isolation for said MUX/DEMUX module and said bandpass filter is connected to a collimator.

11. An optical module platform comprising:
a plurality of placement hallow-openings opened on said platform for placing and supporting a plurality of optical components at substantially predefined fixed positions and orientation.

12. The optical module platform of claim 11 wherein:
said hallow openings are opened on said platform for placing and supporting a plurality of optical transmitting means substantially having a fishbone-shaped configuration.

13. The optical module platform of claim 11 wherein:
said hallow openings are opened on said platform for placing and supporting a plurality of optical transmitting means substantially having a comb-shaped configuration.

14. The optical module platform of claim 11 wherein:
at least one of said hallow openings is an opened groove for placing a optical fiber therein.

15. The optical module platform of claim 11 wherein:
at least one of said hallow openings is an opened V-groove for placing a optical fiber therein.

16. The optical module platform of claim 1 wherein:
said platform composed of material of thermal expansion coefficient smaller than one micro-meter/° C. (μm/m° C.).

17. A method for configuring an optical module comprising:
supporting a plurality of optical components on a platform by opening a plurality of placement hallow-openings on said platform for placing and supporting said optical components at substantially predefined fixed positions and orientation.

18. The method of claim 1 wherein:
said step of opening said hallow openings on said platform is a step of opening said hollow-openings for placing and supporting a plurality of optical transmitting means substantially having a fishbone-shaped configuration.

19. The optical module of claim 17 wherein:
said step of opening said hallow openings on said platform is a step of opening said hollow-openings for placing and supporting a plurality of optical transmitting means substantially having a having a comb-shaped configuration.

20. The method of claim 17 wherein:
said step of opening said hallow openings on said platform is a step of opening at least one of said hollow-openings as an open groove for placing and supporting an fiber optical therein.

21. The method of claim 17 further comprising a step of:
securely bonding and fixing said optical components placed in said hollow-openings to said platform with an adhesive material.

22. The method of claim 17 further comprising a step of:
forming said platform with a material having a thermal expansion coefficient smaller than one micro-meter/° C. (μm/m° C.).

23. A method for forming an optical module platform comprising:
a plurality of placement hallow-openings on said platform at substantially predefined fixed positions and orientation provided for placing and supporting a plurality of optical components therein.

24. The method of claim 23 wherein:
said step of opening said hallow openings further includes a step of opening said hollowing openings on said platform having a substantially fishbone-shaped configuration for placing and supporting a plurality of optical transmitting means therein.

25. The method of claim 23 wherein:
said step of opening said hallow openings further includes a step of opening said hollowing openings on said platform having a substantially comb-shaped configuration for placing and supporting a plurality of optical transmitting means therein.

26. The method of claim 23 wherein:
said step of opening said hallow openings further includes a step of opening at least one said hollowing openings on said platform as an opened groove for placing an optical component therein.

27. The method of claim 23 wherein:
said step of opening said hallow openings further includes a step of opening at least one said hollowing openings on said platform as an opened V-groove for placing an optical component therein.

28. The method of claim 23 further comprising a step of:
forming said platform with a material of a thermal expansion coefficient smaller than one micro-meter/° C. (μm/m° C.).
